(19) United States
(12) Patent Application Publication
(10) Pub. No.: US 2015/0222022 A1
(43) Pub. Date: Aug. 6, 2015

(54) INTERLEAVED ORTHOGONAL LINEAR ARRAYS ENABLING DUAL SIMULTANEOUS CIRCULAR POLARIZATION

(71) Applicants: Nathan Kundtz, Kirkland, WA (US); Adam Bily, Seattle, WA (US)

(72) Inventors: Nathan Kundtz, Kirkland, WA (US); Adam Bily, Seattle, WA (US)

(21) Appl. No.: 14/610,787

(22) Filed: Jan. 30, 2015

Related U.S. Application Data
(60) Provisional application No. 61/934,605, filed on Jan. 31, 2014.

(51) Int. Cl. H01Q 13/18; H01Q 21/24

(52) U.S. Cl. CPC H01Q 13/18; H01Q 21/24

(57) ABSTRACT

An antenna apparatus and method for using the same are disclosed. In one embodiment, the antenna apparatus comprises two sets of orthogonal linearly polarized antenna elements interleaved with each other to receive multiple waves of differing polarizations simultaneously; and a coupling interface having two input ports coupled to receive signals from the two sets of orthogonal linearly polarized antenna elements and having two output ports to output signals with left hand circular polarization (LHCP) and right hand circular polarization (RHCP).

### PRIORITY

The present patent application claims priority to and incorporates by reference the corresponding provisional patent application Ser. No. 61/934,605, titled, “INTERLEAVED ORTHOGONAL LINEAR ARRAYS ENABLING DUAL SIMULTANEOUS CIRCULAR POLARIZATION” filed on Jan. 31, 2014.

### FIELD OF THE INVENTION

Embodiments of the present invention relate to the field of antennas; more particularly, embodiments of the present invention relate to an antenna apparatus that receives both orthogonal polarizations simultaneously using interleaved orthogonal linear arrays.

### BACKGROUND OF THE INVENTION

DirecTV® HD SlimLine dish and system architecture is a commercially available product that is a Direct-To-Home receive-only system that supports reception of both orthogonal polarizations simultaneously. In this case, the polarizations are left hand circular polarization (LHCP) and right hand circular polarization (RHCP). This architecture is a Ka-band antenna with multiple feed horns with various polarizations covering various bands.

The DirecTV® HD SlimLine dish and system supports instantaneous bandwidth. More specifically, the DirecTV system supports 500 MHz instantaneously. Because of the relatively broad instantaneous bandwidth and the simultaneous orthogonal circular polarization reception which allows frequency reuse, the system can receive many high definition channels simultaneously.

One problem with the DirecTV system is that the antenna cannot automatically acquire a satellite link. In such a system, the dish must be positioned correctly in order to enable reception.

Another problem with Direct-To-Home systems such as DirecTV is that they are receive-only. That is, they do not have the capability to receive and transmit with the same antenna. If the transmit function is needed in the system, a separate antenna, with associated control and support, is needed.

Thinkom Solutions Continuous Transverse Stub technology supports dual simultaneous reception of multiple polarizations, but has limitations in terms of beam performance, which is particularly important for transmit applications when it is crucial to meet beam performance requirements.

### SUMMARY OF THE INVENTION

An antenna apparatus and method for using the same are disclosed. In one embodiment, the antenna apparatus comprises two sets of orthogonal linearly polarized antenna elements interleaved with each other to receive multiple waves of differing polarizations simultaneously; and a coupling interface having two input ports coupled to receive signals from the two sets of orthogonal linearly polarized antenna elements and having two output ports to output signals with left hand circular polarization (LHCP) and right hand circular polarization (RHCP).

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates an example of interleaved orthogonal linearly polarized antennas.

FIG. 2 illustrates an interleaved orthogonal linear polarizations showing A+B∠90° in one circular polarization sense and A+B∠−90° in the other.

FIG. 3 illustrates one embodiment of a 90° hybrid coupler.

FIG. 4 illustrates one embodiment of a feeding network.

FIG. 5 is a flow diagram of one embodiment of the process performed by the antenna apparatus described herein.

FIG. 6 is a block diagram of one embodiment of a television system.

FIG. 7A illustrates a perspective view of one row of antenna elements that includes a waveguide and a reconfigurable resonator layer.

FIG. 7B illustrates one embodiment of a tunable resonator/slot.

FIG. 7C illustrates a cross section view of one embodiment of a waveguide.

FIG. 8 illustrates an alternative embodiment of an antenna.

### DETAILED DESCRIPTION

An antenna is described. In one embodiment, the antenna comprises interleaved orthogonal linearly polarized antennas, with rows of antenna elements, where the rows are spaced closely to each other, and a 90° hybrid coupler having two input ports and two output ports. Each co-polarized linear row is fed into one of the input ports of the hybrid coupler, while all oppositely polarized linear rows are fed into the other input ports of the hybrid coupler. The two output ports of the hybrid coupler then produce LHCP and RHCP.

In one embodiment, the antenna apparatus operates as a scanning antenna system that does not require the positioning of the prior art antenna dishes. The antenna system allows automatic satellite and signal acquisition.

Furthermore, in one embodiment, the antenna system includes a transmit function that, while subject to FCC and ITU beam performance requirements, is capable of transmitting from the same antenna that performs reception of RF signals of opposite polarizations.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

### Overview

An antenna apparatus is disclosed. In one embodiment, the antenna apparatus is a flat panel, slotted array antenna with antenna elements in waveguides, which form a waveguide array. In one embodiment, the antenna apparatus includes a pair of orthogonal linearly polarized antennas coupled to a hybrid coupler (e.g., a 90° hybrid coupler).

In one embodiment, the pair of orthogonal linearly polarized antennas has antenna elements that are interleaved with each other to receive multiple waves of differing polarizations (e.g., multiple waves of circular polarization) simultaneously (while the antenna points in one direction). In one embodiment, the antenna apparatus receives multiple waves of circular polarization of the Ka-band. Note that the teachings disclosed herein may be used to receive other frequency bands. Similarly, the teachings disclosed herein may be used to transmit multiple waves of differing polarizations (e.g., multiple waves of circular polarization).

In one embodiment, the interleaved orthogonal linearly polarized antennas comprise two slotted array antennas with two sets of rows of antenna elements. The two sets of rows are interleaved and adjacent with each other, with the antenna elements in the first set of rows being oriented in a first orientation and the antenna elements in the second set of rows being oriented in a second, different orientation. In one embodiment, the first and second orientations are at +45° and −45° with respect to each other, thereby being 90° apart.

In one embodiment, the each row of antenna elements are integrated into a waveguide. In one embodiment, the distance between waveguides is λ/3 along the channel. In another embodiment, the distance between waveguides is λ/4. For example, at 20 GHz, λ is 1.5cm (15mm), which is approximately 0.6″, thereby making the spacing between waveguides to be approximately 0.15″.

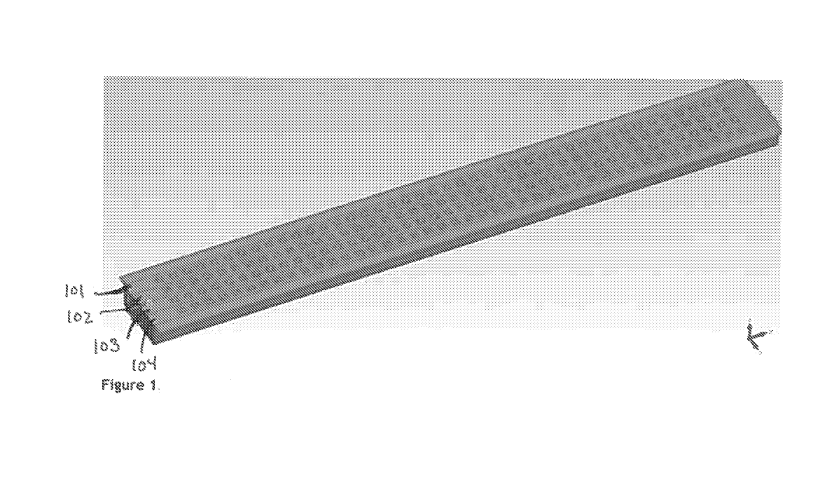

FIG. 1 illustrates an example of interleaved orthogonal linearly polarized antennas. Referring to FIG. 1, four channels, with 42 elements per channel spaced 0.12 inches apart, are shown. This is only an example and only four channels are shown for illustration. Typical antenna implementations would include more than four channels, or rows of antenna elements. Also, the rows may have more or less than 42 antenna elements.

As shown, the four channels comprises adjacent linear rows, or strips, of antenna elements, namely 101-104. In a Ka-band implementation, the total number of rows includes 100 rows of 200 elements. In one embodiment, the spacing between elements is equal to λ/5×λ/4, where X is the wavelength corresponding to the highest frequency of operation. In such a case, the total number of elements for a Kₐ-band antenna is about 10,000. In one embodiment, each of the antenna elements is in a waveguide.

In one embodiment, each channel or row is linearly polarized in one orientation and the channels are interleaved with channels having an orthogonal orientation. For example, in one embodiment, the odd-numbered channels are linearly polarized in a first orientation, and the even-number channels are linearly polarized in a second orientation that is orthogonal to the first orientation. To that end, the antenna elements in individual rows are oriented the same way. That is, antenna elements in row 101 are oriented in one way, antenna elements in row 102 are oriented in one way, antenna elements in row 103 are oriented in one way, and antenna elements in row 104 are oriented in one way. However, adjacent rows of antenna elements are oriented in different, orthogonal orientations, with every other row having the same orientation. For example, antenna elements in rows 101 and 103 are oriented in the same way, while antenna elements in rows 102 and 104 are oriented in the same way. Thus, the rows with elements oriented one way are interleaved with rows with elements oriented another way.

In one embodiment, antenna elements in rows 101 and 103 are oriented at +45°, and antenna elements in rows 102 and 104 are oriented at −45°, with respect to the row orientation (or the Poynting vector of the feed wave). Thus, the two orientations are 90° apart with respect to each other. Other orientations are possible.

The radio-frequency (RF) energy impinges on the antenna elements in the linear rows and the energy is taken out of the rows and input ultimately into a coupling interface (e.g., a hybrid coupler). In one embodiment, the linear rows are coupled to ports of a 90° hybrid coupler. In one embodiment, the hybrid coupler has two input ports coupled to receive signals from the pair of orthogonal linearly polarized antennas. In one embodiment, each orthogonal linearly polarized antennas comprises linear rows of antenna elements, wherein a first set of co-polarized linear rows are fed into a first of two input ports of the hybrid coupler and a second set of linear rows oppositely polarized are fed into a second of two input ports of the hybrid coupler.

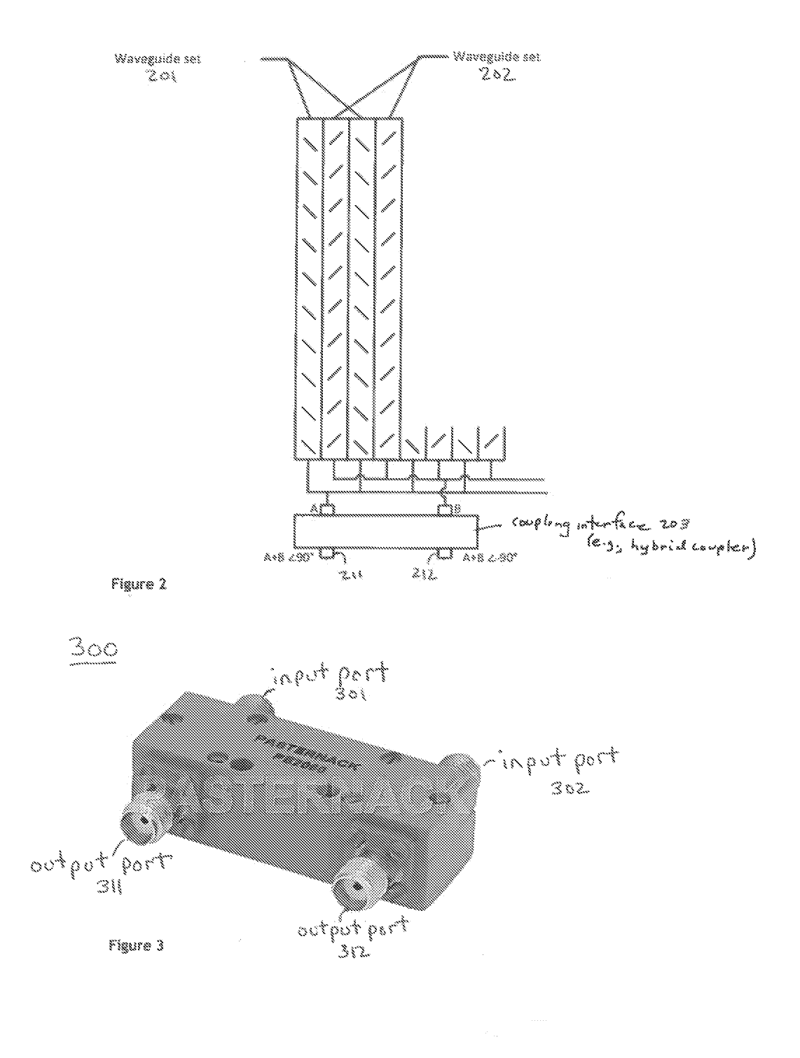

FIG. 2 illustrates rows of antenna elements coupled to a hybrid coupler. Referring to FIG. 2, waveguide set 201 with antenna elements oriented one way are coupled to port A of coupling interface 203 and waveguide set 202 with antenna elements oriented another, different way are coupled to port B of coupling interface 203. Note that the waveguides of set 201 are interleaved with waveguides of set 202. In one embodiment, coupling interface 203 comprises a hybrid coupler (e.g., a 90° hybrid coupler). In another embodiment, coupling interface 203 comprises discrete components (e.g., digital circuits, analog circuits, analog and digital circuits) that extract signals (e.g., RHCP and LHCP signals).

As discussed above, in one embodiment, a pair of combiners is used to couple the two linearly polarized antennas to coupling interface 203. In one embodiment, each combiner has a set of inputs and an output and combines signals from its two sets of inputs to produce one signal on each of its two outputs, which are fed into the inputs of the hybrid coupler.

In one embodiment, the combiners comprise a pair of feeding networks. In one embodiment, each feeding network comprises a set of inputs coupled to the rows of antenna elements of one of the two antennas. In other words, one feeding network receives the signals produced by the antenna with elements in rows linearly polarized in one direction and the other feeding network receives the signals produced by the other antenna with elements in linear rows polarized in the opposite direction.

In one embodiment, the feeding network operates as a passive divider to repeatedly combine pairs of signals from one set of its inputs into a single signal. For example, the outputs of waveguides 1 and 3 are combined together to form a single signal. At the same time, the outputs of waveguides 5 and 7 are combined together to form a single signal. This occurs during generation one. Then, during the generation two, the signal resulting from the combination of signals from waveguides 1 and 3 is combined with the signal resulting from the combination of signals from waveguides 5 and 7. Thereafter, this signal is then combined with a signal that was generated in the same manner through generations one and two from waveguides 9, 11, 13 and 15. This process repeats through multiple additional generations until signals from all the odd waveguides have been combined into a single signal. Similarly, a second feeding network combines all the signals from the even waveguides (e.g., waveguides 2, 4, 6, etc.) into a single signal. This is well-known in the art. Thus, the two feeding networks receive the signals from outputs of the two linearly polarized antennas to produce to signals. In one embodiment, the outputs of the combiners include a horizontal (H) linearly polarized signal and a vertical (V) linearly polarized signal.

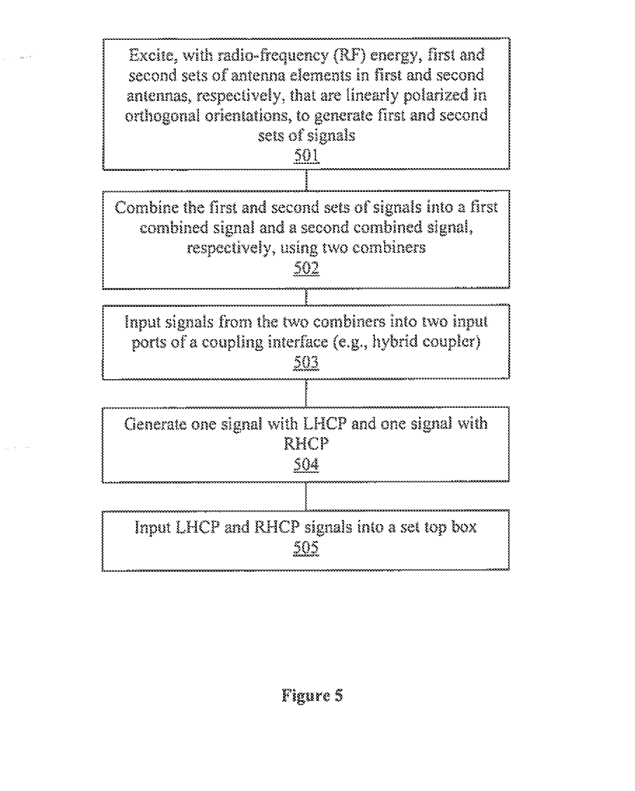

FIG. 4 illustrates one embodiment of a feeding network. The operation of such a feeding network is well-known in the art.

The coupling interface (e.g., a 90° hybrid coupler, etc.) has two output ports to output signals with left hand circular polarization (LHCP) and right hand circular polarization (RHCP) in response to the signals from the orthogonal linearly polarized antennas. Referring back to FIG. 2, the output ports 211 and 212 of coupling interface 203 (e.g., a 90° hybrid coupler, etc.) are shown in relation to ports A and B. The interleaved orthogonal linear polarizations output from coupling interface 203 are shown as A+B∠90° as one circular polarization and A+B∠−90° as the other. In other words, the coupling interface 203 adds the signal on its input port A to a phase shifted (by)90° version of the signal on its input port B to produce one output and adds the signal on its input port A to a phase shifted (by)-90° version of the signal on its input port B to produce the other output. In one embodiment, output ports 211 and 212 of coupling interface 203 produce signals with LHCP and RHCP, respectively.

In summary, in one embodiment, a satellite beams energy down in two polarizations simultaneously (LHCP and RHCP) and the antenna elements are oriented in such a way and fed into the hybrid coupler in such a way to simultaneously pick up the field orientations.

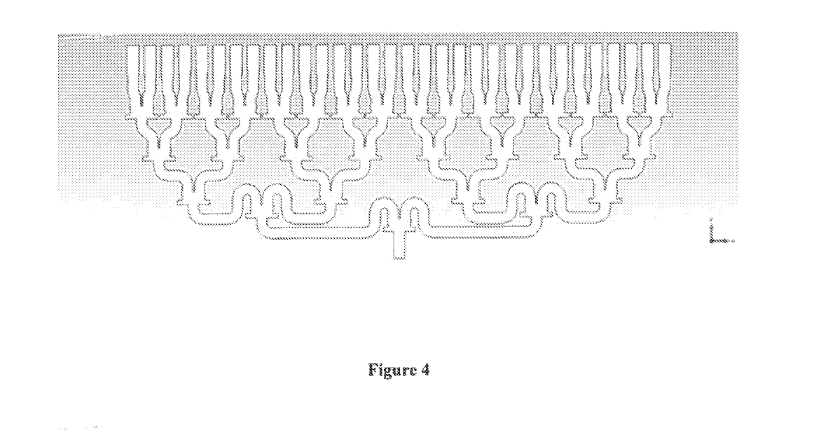

FIG. 3 illustrates one embodiment of a 90-degree hybrid coupler. Referring to FIG. 3, 90-degree hybrid coupler 300 comprises a four-port device with two input ports 301 and 302 and two output ports 311 and 312. Hybrid coupler 300 comprises two cross-over transmission lines over a length of one-quarter wavelength, corresponding with the center frequency of operation.

In one embodiment, the 90° hybrid coupler is a Pasternack PE2060 90-degree hybrid coupler. There are other commercially available 90° hybrid couplers that can be used or other microwave circuit devices that can be implemented in various topologies to perform such a function.

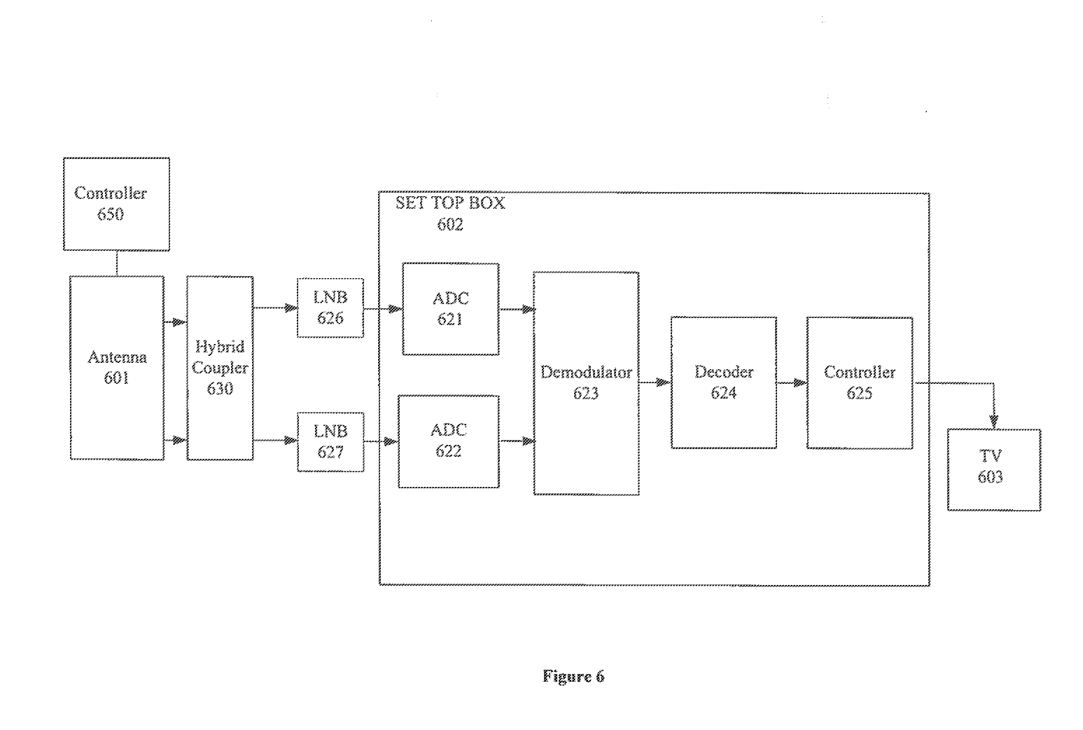

FIG. 5 is a flow diagram of one embodiment of the process performed by the antenna apparatus described herein. In one embodiment, the process includes receiving two radio-frequency (RF) waves having orthogonal polarization using interleaved orthogonal linear arrays and generating, with a coupling interface (e.g., a 90° hybrid coupler, etc.), first and second outputs in response to the two RF waves, where the first output is a signal with LHCP and the second output is a signal with RHCP.

Referring to FIG. 5, the process begins by exciting, with radio-frequency (RF) energy, first and second sets of antenna elements in first and second antennas, respectively, that are linearly polarized in orthogonal orientations, to generate first and second sets of signals (501).

The processing continues by combining the first and second sets of signals into a first combined signal and a second combined signal, respectively, using two combiners (e.g., two feeding networks) (502).

The first and second combined signals are input into two ports of a coupling interface such as a 90° hybrid coupler (503), which generates one signal with LHCP and one signal with RHCP (504). The LHCP and RHCP signals from the coupling interface are input into a set top box (505).

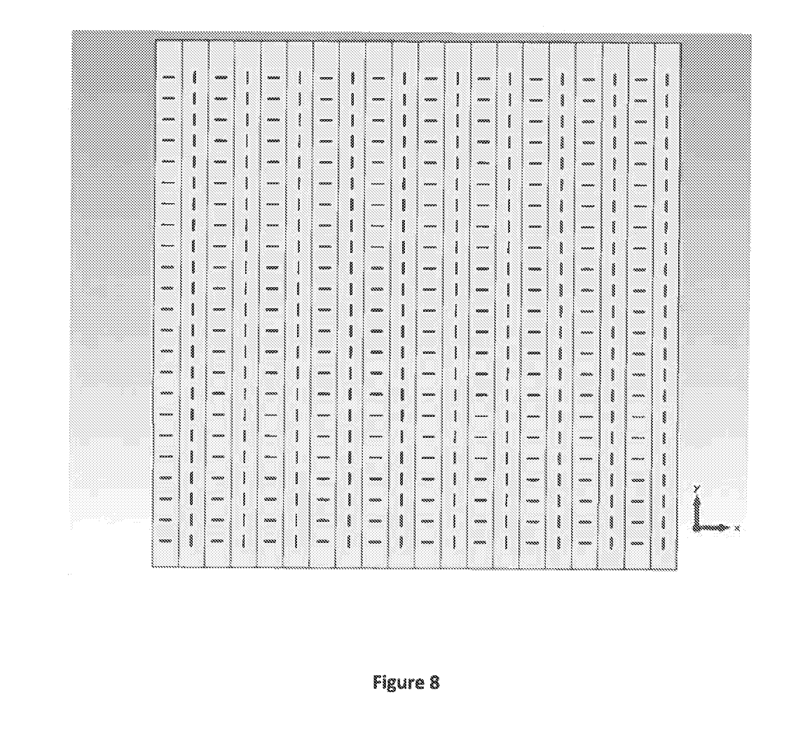

FIG. 8 illustrates an alternative embodiment of an antenna. Referring to FIG. 8, a single continuous wave guiding medium (structure) is shown having rows of antenna elements that include orthogonal interleaved elements oriented at 0° and 90°. As with the waveguide implementation discussed above, the purpose of the element orientation is to excite orthogonal RF signals simultaneously, commonly referred to as H and V. In this case, in order to do so, the antenna is excited from two orthogonal directions on adjacent sides of the structure (e.g., a square antenna array) and relies on the selectivity of the 0° and 90° elements to only be excited by one or the other feed waves. More specifically, in one embodiment, the feed orientation is from any 2 adjacent sides of the structure, and may be made using a fairly common device such as, for example, a sectoral horn. The 0° elements are only excited by waves from one of the edges of the structure, and the 90° oriented elements are only excited by waves coming from the other adjacent edge of the structure. The rows of excited elements generate signals that are coupled, via a combiner, to the 90° hybrid coupler and are processed in the same manner as those generated by the waveguide implementation,

### A Television System Embodiment

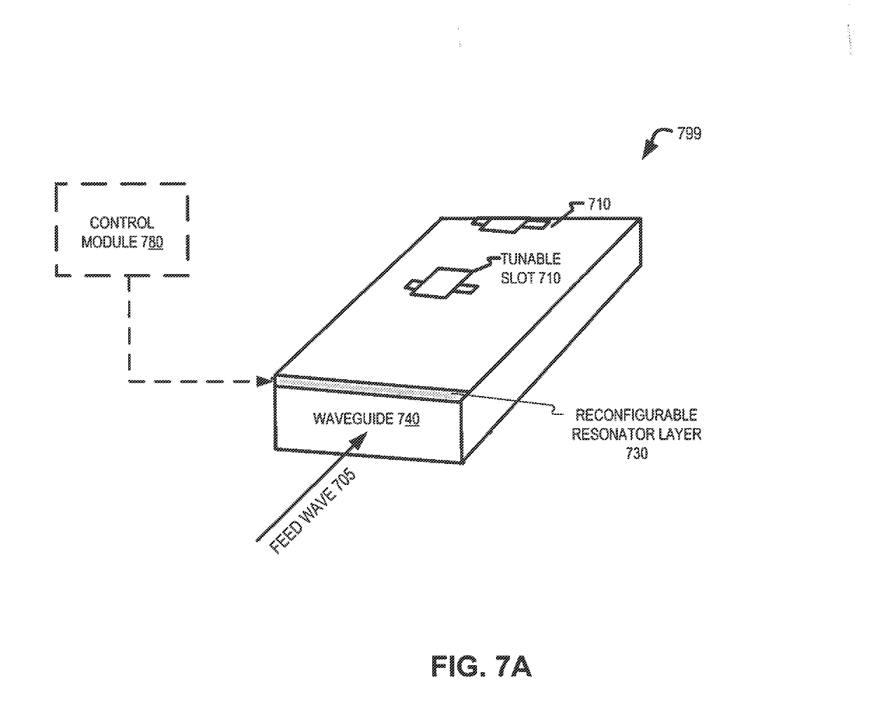

Once the signals are output from the hybrid coupler, they are brought into the set top box (e.g., a DirectTV receiver) of a television system. FIG. 6 is a block diagram of one embodiment of a communication system. Referring to FIG. 6, antenna 601 is coupled 90° hybrid coupler 630. The 90° hybrid coupler 630 is coupled to a pair of low noise block down converters (LNBs) 626 and 627, which perform a noise filtering function and a down conversion function in a manner well-known in the art. In one embodiment, LNBs 626 and 627 are in an out-door unit (ODU). In another embodiment, LNBs 626 and 627 are integrated into the antenna apparatus. LNBs 626 and 627 are coupled to a set top box 602, which is coupled to television 603. Set top box 601 includes a pair of analog-to-digital converters (ADCs) 621 and 622, which are coupled to LNBs 626 and 627, to convert the two signals output from the 90° hybrid coupler into digital format.

Once converted to digital format, the signals are demodulated by demodulator 623 and decoded by decoder 624 to obtain the encoded data on the LHCP wave and the RHCP wave. The decoded data is then sent to controller 625, which sends it to television 603.

Controller 650 controls antenna 601, including the antenna elements of the interleaved orthogonal linearly polarized antennas.

The techniques described herein may be used in the transmit direction as well as the receive direction. In such a case, a signal to be transmitted is input and amplified by a high power amplifier (HPA) and then input into the input ports of a 90° hybrid coupler via a switch. The outputs of the 90° hybrid coupler are coupled to a combiner that acts as a divider to generate the signals that drive interleaved orthogonal linearly polarized antenna elements. Every antenna can be operated in both transmit and receive and works in the same way. Note, however, that the system elements in the transmit direction may have to be scaled (relatively to the receive system elements) to function using a different frequency if the transmit and receive frequencies are different.

The techniques described herein are applicable to a number of applications, including but not limited to, automatically acquiring Direct to Home (DTH), communications-on-the-pause, and fully mobile platforms.

### Antenna Elements

In one embodiment, the antenna elements comprise a group of patch antennas. This group of patch antennas comprises an array of scattering metamaterial elements. In one embodiment, each scattering element in the antenna system is part of a unit cell that consists of a lower conductor, a dielectric substrate and an upper conductor that embeds a complementary electric inductive-capacitive resonator (“complementary electric LC” or “CELL”) that is etched in or deposited onto the upper conductor.

In one embodiment, a liquid crystal (LC) is injected in the gap around the scattering element. Liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) can be controlled by adjusting the bias voltage across the liquid crystal. Using this property, the liquid crystal acts as an on/off switch for the transmission of energy from the guided wave to the CELC. When switched on, the CELC emits an electromagnetic wave like an electrically small dipole antenna.

Controlling the thickness of the LC increases the beam switching speed. A fifty percent (50%) reduction in the gap between the lower and the upper conductor (the thickness of the liquid crystal) results in a fourfold increase in speed. In another embodiment, the thickness of the liquid crystal results in a beam switching speed of approximately fourteen milliseconds (14 ms). In one embodiment, the LC is doped in a manner well-known in the art to improve responsiveness so that a seven millisecond (7 ms) requirement can be met.

In one embodiment, the feed geometry of this antenna system allows the antenna elements to be positioned at forty five degree (45°) angles to the vector of the wave in the wave feed. This position of the elements enables control of the polarization of the free space wave received by or generated from the elements. In one embodiment, the antenna elements are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

To generate circular polarization from two sets of linearly polarized elements, the two sets of elements are perpendicular to each other and simultaneously have equal amplitude excitation. Rotating them +/−45 degrees relative to the feed wave excitation achieves both desired features at once. Rotating one set 0 degrees and the other 90 degrees would achieve the perpendicular goal, but not the equal amplitude excitation goal. Note that 0 and 90 degrees may be used to achieve isolation when feeding the array of antenna elements in a single structure (e.g., the square medium of FIG. 8) from two sides as described above.

The elements are turned off or on by applying a voltage to the patch using a controller. Traces to each patch are used to provide the voltage to the patch antenna. The voltage is used to tune or detune individual elements to effectuate beam forming. The voltage required is dependent on the liquid crystal mixture being used, the resulting threshold voltage required to begin to tune the liquid crystal, and the maximum saturation voltage (beyond which no higher voltage produces any effect except to eventually degrade or short circuit through the liquid crystal). In one embodiment, matrix drive is used to apply voltage to the patches in order to control the coupling.

The control structure for the antenna system has 2 main components; the controller, which includes drive electronics, for the antenna system, is below the wave scattering structure, while the matrix drive switching array is interspersed throughout the radiating RF array in such a way as to not interfere with the radiation. In one embodiment, the drive electronics for the antenna system comprise commercial off-the shelf LCD controls used in commercial television appliances that adjust the bias voltage for each scattering element by adjusting the amplitude of an AC bias signal to that element.

In one embodiment, the controller also contains a microprocessor executing the software. The control structure may also incorporate sensors (nominally including a GPS receiver, a three axis compass and an accelerometer) to provide location and orientation information to the processor. The location and orientation information may be provided to the processor by other systems in the earth station and/or may not be part of the antenna system.

More specifically, the controller controls which elements are turned off and those elements turned on at the frequency of operation. The elements are selectively detuned for frequency operation by voltage application.

For transmission, a controller supplies an array of voltage signals to the RF patches to create a modulation, or control pattern. The control pattern causes the elements to be turned on or off. In one embodiment, multistate control is used in which various elements are turned on and off to varying levels, further approximating a sinusoidal control pattern, as opposed to a square wave (i.e., a sinusoid gray shade modulation pattern). Some elements radiate more strongly than others, rather than some elements radiate and some do not. Variable radiation is achieved by applying specific voltage levels, which adjusts the liquid crystal permittivity to varying amounts, thereby detuning elements variably and causing some elements to radiate more than others.

The generation of a focused beam by the metamaterial array of elements can be explained by the phenomenon of constructive and destructive interference. Individual electromagnetic waves sum up (constructive interference) if they have the same phase when they meet in free space and waves cancel each other (destructive interference) if they are in opposite phase when they meet in free space. If the slots in a slotted antenna are positioned so that each successive slot is positioned at a different distance from the excitation point of the guided wave, the scattered wave from that element will have a different phase than the scattered wave of the previous slot. If the slots are spaced one quarter of a guided wavelength apart, each slot will scatter a wave with a one fourth phase delay from the previous slot.

Using the array, the number of patterns of constructive and destructive interference that can be produced can be increased so that beams can be pointed theoretically in any direction plus or minus ninety degrees (90°) from the bore sight of the antenna array, using the principles of holography. Thus, by controlling which metamaterial unit cells are turned on or off (i.e., by changing the pattern of which cells are turned on and which cells are turned off), a different pattern of constructive and destructive interference can be produced, and the antenna can change the direction of the wave front. The time required to turn the unit cells on and off dictates the speed at which the beam can be switched from one location to another location.

In one embodiment, the beam pointing angle for both interleaved antennas is defined by the modulation, or control pattern specifying which elements are on or off. In other words, the control pattern used to point the beam in the desired way is dependent upon the frequency of operation.

In one embodiment, the antenna system produces one steerable beam for the uplink antenna and one steerable beam for the downlink antenna.

In one embodiment, the antenna system uses metamaterial technology to receive beams and to decode signals from the satellite and to form transmit beams that are directed toward the satellite. In one embodiment, the antenna systems are analog systems, in contrast to antenna systems that employ digital signal processing to electrically form and steer beams (such as phased array antennas). In one embodiment, the antenna system is considered a “surface” antenna that is planar and relatively low profile, especially when compared to conventional satellite dish receivers.

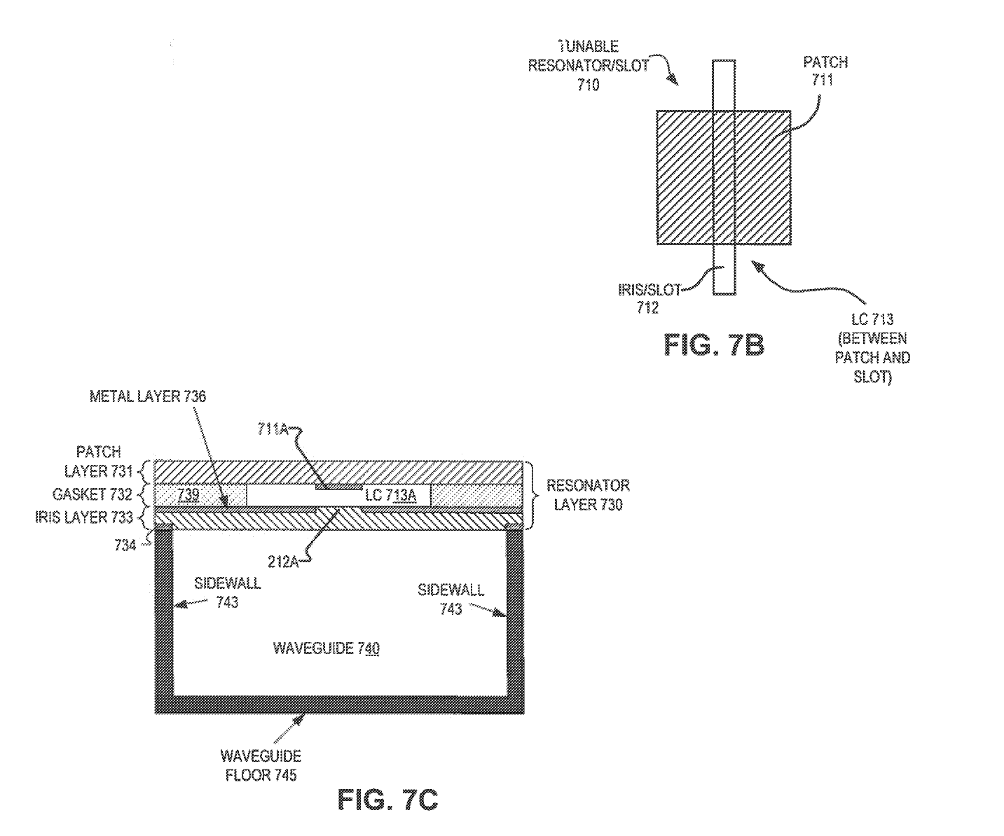

FIG. 7A illustrates a perspective view of one row of antenna elements that includes a waveguide and a reconfigurable resonator layer. It is appreciated that the antenna system includes multiple waveguide structures such as the waveguide illustrated in FIGS. 7A-7C. Reconfigurable resonator layer 730 includes an array of tunable slots 710. The array of tunable slots 710 can be configured to point the antenna in a desired direction. Each of the tunable slots can be tuned/adjusted by varying a voltage across the liquid crystal.

Control module 780 is coupled to reconfigurable resonator layer 730 to modulate the array of tunable slots 710 by varying the voltage across the liquid crystal in FIG. 7A. Control module 780 may include a Field Programmable Gate Array (“FPGA”), a microprocessor, or other processing logic. In one embodiment, control module 780 includes logic circuitry (e.g., multiplexer) to drive the array of tunable slots 710. In one embodiment, control module 780 receives data that includes specifications for a holographic diffraction pattern to be driven onto the array of tunable slots 710. The holographic diffraction patterns may be generated in response to a spatial relationship between the antenna and a satellite so that the holographic diffraction pattern steers the downlink beams (and uplink beam if the antenna system performs transmit) in the appropriate direction for communication. Although not drawn in each figure, a control module similar to control module 780 may drive each array of tunable slots described in the figures of the disclosure.

Radio Frequency (“RF”) holography is also possible using analogous techniques where a desired RF beam can be generated when an RF reference beam encounters an RF holographic diffraction pattern. In the case of satellite communications, the reference beam is in the form of a feed wave, such as feed wave 705 (approximately 20 GHz in some embodiments). To “steer” a feed wave (either for transmitting or receiving purposes), an interference pattern is calculated between the desired RF beam (the object beam) and the feed wave (the reference beam). The interference pattern is driven onto the array of tunable slots 710 as a diffraction pattern so that the feed wave is “steered” into the desired RF beam (having the desired shape and direction). In other words, the feed wave encountering the holographic diffraction pattern “reconstructs” the object beam, which is formed according to design requirements of the communication system.

FIG. 7B illustrates a tunable resonator/slot 710, in accordance with an embodiment of the disclosure. Tunable slot 710 includes an iris/slot 712, a radiating patch 711, and liquid crystal 713 disposed between iris 712 and patch 711. In one embodiment, radiating patch 711 is co-located with iris 712.

FIG. 7C illustrates a cross section view of a waveguide, in accordance with an embodiment of the disclosure. Waveguide 740 is bound by waveguide sidewalls 743, waveguide floor 745, and a metal layer 736 within iris layer 733, which is included in reconfigurable resonator layer 730. Iris/slot 712 is defined by openings in metal layer 736. Feed wave 705 may have a microwave frequency compatible with satellite communication channels. Waveguide 740 is dimensioned to efficiently guide feed wave 705.

Reconfigurable resonator layer 730 also includes gasket layer 732 and patch layer 731. Gasket layer 732 is disposed between patch layer 731 and iris layer 733. Note that in one embodiment, a spacer could replace gasket layer 732. Iris layer 733 may be a printed circuit board (“PCB”) that includes a copper layer as metal layer 736. Openings may be etched in the copper layer to form slots 712. Iris layer 733 is conductively coupled to waveguide 740 by conductive bonding layer 734, in FIG. 7C. Note that in an embodiment such as shown in FIG. 8 the iris layer is not conductively coupled by a conductive bonding layer and is instead interfaced with a non-conducting bonding layer.

Patch layer 731 may also be a PCB that includes metal as radiating patches 711. In one embodiment, gasket layer 732 includes spacers 739 that provide a mechanical standoff to define the dimension between metal layer 736 and patch 711. In one embodiment, the spacers are 75 microns, but other sizes may be used (e.g., 25 microns). Tunable resonator/slot 710A includes patch 711A, liquid crystal 713A, and iris 712A. Tunable resonator/slot 710B includes patch 711B, liquid crystal 713B and iris 712B. The chamber for liquid crystal 713 is defined by spacers 739, iris layer 733 and metal layer 736. When the chamber is filled with liquid crystal, patch layer 731 can be laminated onto spacers 739 to seal liquid crystal within resonator layer 730.

A voltage between patch layer 731 and iris layer 733 can be modulated to tune the liquid crystal in the gap between the patch and the slots 710. Adjusting the voltage across liquid crystal 713 varies the capacitance of slot 710. Accordingly, the reactance of slot 710 can be varied by changing the capacitance. Resonant frequency of slot 710 also changes according to the equation

$$f = \frac{1}{2 π \sqrt{LC}}$$

where f is the resonant frequency of slot 710 and L and C are the inductance and capacitance of slot 710, respectively. The resonant frequency of slot 710 affects the energy radiated from feed wave 705 propagating through the waveguide. As an example, if feed wave 705 is 20 GHz, the resonant frequency of a slot 710 may be adjusted (by varying the capacitance) to 17 GHz so that the slot 710 couples substantially no energy from feed wave 705. Or, the resonant frequency of a slot 710 may be adjusted to 20 GHz so that the slot 710 couples energy from feed wave 705 and radiates that energy into free space. Although the examples given are binary (fully radiating or not radiating at all), full grey scale control of the reactance, and therefore the resonant frequency of slot 710 is possible with voltage variance over a multi-valued range. Hence, the energy radiated from each slot 710 can be finely controlled so that detailed holographic diffraction patterns can be formed by the array of tunable slots.

In one embodiment, sidewalls 743 and waveguide floor 745 are a contiguous structure. In one embodiment, an extruded metal (e.g., extruded aluminum) forms the contiguous structure. In an alternative embodiment, the contiguous structure may be milled/machined from solid metal stock. Other techniques and materials may be utilized to form the contiguous waveguide structure.

In one embodiment, tunable slots in a row are spaced from each other by λ/5. Other spacings may be used. In one embodiment, each tunable slot in a row is spaced from the closest tunable slot in an adjacent row by λ/2, and, thus, commonly oriented tunable slots in different rows are spaced by λ/4, though other spacings are possible (e.g., λ/5). In another embodiment, each tunable slot in a row is spaced from the closest tunable slot in an adjacent row by λ/3.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. An antenna apparatus comprising:
two sets of orthogonal linearly polarized antenna elements interleaved with each other to receive multiple waves of differing polarizations simultaneously; and
a coupling interface having two input ports coupled to receive signals from the two sets of orthogonal linearly polarized antenna elements and having two output ports to output signals with left hand circular polarization (LHCP) and right hand circular polarization (RHCP).

2. The antenna apparatus defined in claim 1 wherein each set of orthogonal linearly polarized elements is part of an orthogonal linearly polarized antenna.

3. The antenna apparatus defined in claim 2 wherein each orthogonal linearly polarized antennas comprises a plurality of linear rows of antenna elements, wherein co-polarized linear rows are fed into a first of the two input ports, while all oppositely polarized linear rows are fed into a second of the input ports.

4. The antenna apparatus defined in claim 3 wherein the each row of antenna elements comprises a waveguide containing the antenna elements.

5. The antenna apparatus defined in claim 3 wherein the plurality of rows comprises a first set of rows of antenna elements and a second set of rows of antenna elements, rows of the first and second sets being interleaved with each other, with the antenna elements in the first set of rows being oriented in a first orientation and the antenna elements in the second set of rows being oriented in a second orientation, the second orientation being different than the first orientation.

6. The antenna apparatus defined in claim 5 wherein the first and second orientations being 90° with respect to each other.

7. The antenna apparatus defined in claim 1 wherein the two sets of orthogonal linearly polarized antenna elements interleaved with each other are part of a single planar structure and comprise orthogonal interleaved antenna elements oriented at 0° and 90°.

8. The antenna apparatus defined in claim 7 wherein planar structure is feed from two orthogonal directions on adjacent sides of the structure.

9. The antenna apparatus defined in claim 1 wherein the coupling interface comprises a hybrid coupler.

10. The antenna apparatus defined in claim 9 wherein the hybrid coupler is a 90° hybrid coupler.

11. The antenna apparatus defined in claim 1 further comprising a feeding network coupled to interface the antennas to the coupling interface.

12. The antenna apparatus defined in claim 11 wherein the feeding network comprises two sets of inputs and two outputs, each set of the two sets of inputs coupled to rows of antenna elements of one of the two sets of orthogonal linearly polarized antenna elements and to combine signals on its inputs into a single signal on one of the two outputs.

13. An antenna apparatus comprising:
two sets of orthogonal linearly polarized antenna elements interleaved with each other to receive two waves of differing polarizations simultaneously;
a combiner having two sets of inputs and two outputs, each of the two sets of inputs coupled to one of the two antennas; and
a 90° hybrid coupler having two input ports coupled to outputs of the combiner and having two output ports to output signals with left hand circular polarization (LHCP) and right hand circular polarization (RHCP).

14. The antenna apparatus defined in claim 13 wherein each set of orthogonal linearly polarized elements is part of an orthogonal linearly polarized antenna.

15. The antenna apparatus defined in claim 14 wherein each orthogonal linearly polarized antennas comprises a plurality of linear rows of antenna elements, wherein co-polarized linear rows are fed into a first of the two input ports, while all oppositely polarized linear rows are fed into a second of the input ports.

16. The antenna apparatus defined in claim 15 wherein the each row of antenna elements comprises a waveguide containing the antenna elements.

17. The antenna apparatus defined in claim 15 wherein the plurality of rows comprises a first set of rows of antenna elements and a second set of rows of antenna elements, rows of the first and second sets being interleaved with each other, with the antenna elements in the first set of rows being oriented in a first orientation and the antenna elements in the second set of rows being oriented in a second orientation, the second orientation being different than the first orientation.

18. The antenna apparatus defined in claim 17 wherein the first and second orientations being 90 degrees apart with respect to each other.

19. The antenna apparatus defined in claim 13 wherein the two sets of orthogonal linearly polarized antenna elements interleaved with each other are part of a single planar structure and comprise orthogonal interleaved antenna elements oriented at 0° and 90°.

20. The antenna apparatus defined in claim 19 wherein planar structure is feed from two orthogonal directions on adjacent sides of the structure.

21. The antenna apparatus defined in claim 13 wherein the combiner comprises a feeding network.

22. The antenna apparatus defined in claim 21 wherein the feeding network is operable to combine pairs of signals into a single signal repeatedly to produce a signal on one of the two outputs.

23. The antenna apparatus defined in claim 13 further comprising:
a pair of analog-to-digital converters (ADCs) coupled to the outputs of the 90 degree hybrid coupler; and
a demodulator coupled to the pair of ADCs.

24. An antenna apparatus comprising:
a slotted array antenna having antenna elements oriented in a plurality of rows, the plurality of rows being adjacent to each other, with antenna elements in each row being oriented in one polarized orientation and antenna elements of adjacent rows being oriented in an oppositely polarized orientation; and
a coupling interface having two input ports coupled to receive signals from the antennas and having two output ports to output signals with left hand circular polarization (LHCP) and right hand circular polarization (RHCP).

25. The antenna apparatus defined in claim 24 wherein the slotted array antenna being two orthogonal linearly polarized antennas.

26. The antenna apparatus defined in claim 24 wherein the each row of antenna elements comprises a waveguide containing the antenna elements.

27. The antenna apparatus defined in claim 24 wherein the different orientations comprises first and second orientations 90 degrees apart with respect to each other.

28. The antenna apparatus defined in claim 24 further comprising a combiner coupled to interface the antennas to the coupling interface.

29. The antenna apparatus defined in claim 28 wherein the combiner comprises a feeding network.

30. The antenna apparatus defined in claim 29 wherein the feeding network is operable to combine signals on its inputs into a single signal on one of the two outputs.

31. The antenna apparatus defined in claim 23 wherein the coupling interface comprises a 90° hybrid coupler.

32. A method comprising:
receiving two radio-frequency (RF) waves having orthogonal polarization using interleaved orthogonal linear arrays; and
generating, with a coupling interface, first and second outputs in response to the two RF waves, the first output being a signal with RHCP and the second output being a signal with RHCP.

33. The method defined in claim 32 wherein the coupling interface comprises a 90° hybrid coupler.
